(19) United States
(12) Patent Application Publication
(10) Pub. No.: US 2017/0316681 A1
(43) Pub. Date: Nov. 2, 2017

(54) Smart Stake

(71) Applicant: John C. Oswald, Dayton, OH (US)

(72) Inventor: John C. Oswald, Dayton, OH (US)

(21) Appl. No.: 15/140,354

(22) Filed: Apr. 27, 2016

(51) Int. Cl. G08C 17/02; A01K 3/00; A01K 29/00; E04H 17/00

(52) U.S. Cl. CPC G08C 17/02; A01K 29/00; A01K 3/00; E04H 17/00

(57) ABSTRACT

Electrical fence lines provide an electromagnetic barrier to deter crossing. This barrier becomes compromised by lack of power, grounding of the powered lines, and/or loss of upright structure. Although some monitoring systems use audio and visual alerts (ie horns and blinking lights), they require immediate observation for immediate attention. Radio wave alerts are limited in range and receivers. Cellular phone networks are sometimes used with telecommunication monitoring systems but require specific carriers to communicate to certain cellular devices based on the technology (ie GSM, CDMA) used by the carrier. With the Smart Stake, the Internet and any communications server can be used to send alerts to any cellular device, email address, or networked device on the conditions of the electric fence.

### CROSS REFERENCE

This application has no co-pending or previously filed relation to a previous application.

### FEDERAL FUNDING

No federal support is given for these inventions.

### JOINT RESEARCH

No joint research agreements exist.

### SUMMARY

Immediate notification of failing systems is essential to avoid catastrophic results. With telecommunications, instant alerts are becoming common. With electrical containment systems, such things as barriers to contain livestock and deter trespassers are more easily accomplished. When fence lines and/or power is down, livestock can escape and trespassers can enter; it is all a matter of time. The sooner the failure is detected and fixed, the less chance of these problems.

### DRAWINGS/DESCRIPTIONS

The Smart Stake provides solutions to these afore mentioned problems with data inputs and messaging via Internet connection and email servers to give alerts from an email account.

FIG. 1 (page 8) gives a circuit schematic of the Smart Stake. Standard electrical symbols for components depict the circuitry of the Smart State and the electrical fence line being monitored. The electric fence is a ˜10 kV pulsation current. The circuit board used is an Arduino Uno.

FIG. 2 (page 9) provides the Arduino sketch code compiled in Arduino IDE to monitor the power and the orientation of the fence. This is to be uploaded to the Arduino Uno's processor.

FIG. 3 (pages 10-11) provides the Python programming code to communicate with the Arduino Uno and the email server for input of and reporting of alerts. In this example, I use a gmail account to text to a Verizon Wireless mobile device.

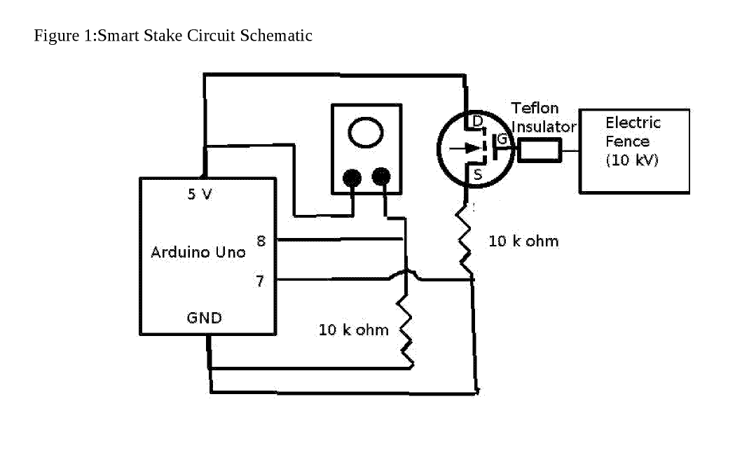

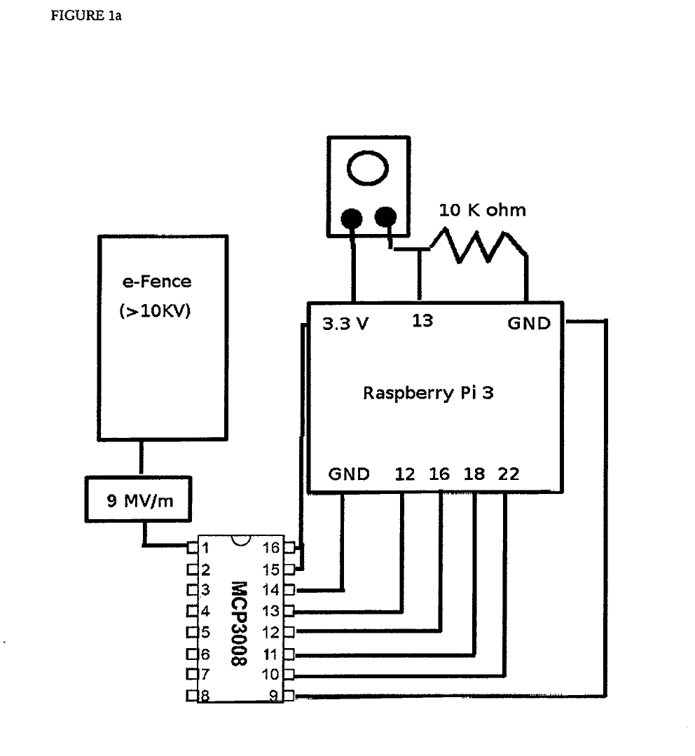

### INVENTION CONSTRUCTION

My innovation and invention, the Smart Stake, resolves the afore mentioned problems. The following material is needed: an Arduino circuit board (ie Arduino Uno), a tilt switch, a metal-oxide-semiconductor field-effect transistor (MOFSET), resistors, Teflon insulator, conducting wires, a breadboard, solder, a soldering iron, a USB cable, and a computer with programming ability and Internet access. Refer to the following assembly instructions:

### SMART STAKE ASSEMBLY INSTRUCTION

1) Connect a wire to the 5V power pin of the Arduino and to a breadboard strip (power strip).

2) Solder a wire to a tilt switch anode and push the other end into the power strip.

3) Connect a ground pin of the Arduino to a breadboard strip (ground strip) with a wire.

4) Connect a wire with a 10 K ohm resistor from the ground strip to the tilt sensor cathode; solder to the cathode of the tilt switch and push the other end into the ground strip.

5) Connect another wire from the tilt switch cathode to digital pin 8 of the Arduino; solder one wire end to the tilt switch cathode and push the other end into digital pin 8.

6) Attach the tilt switch to a fence post or structure to be monitored for upright orientation.

7) To the electric fence (powered down), attach a wire end encased in an insulator (1 mm thick Teflon) to put 10 kV conducted through the wire by the powered fence to <6 V.

8) To the non-encased insulator end of the wire, solder it to the gate pin (G) of a MOFSET.

9) Solder a wire to the MOFSET's drain pin (D) and a wire with a 10 K ohm resistor to the MOFSET's source pin (S).

10) Attach the wire from the drain pin to the power strip.

11) Attach the wire from the source pin to an open breadboard strip (source strip).

12) Attach a wire between the ground strip and the source strip.

13) Attach a wire from the source strip to digital pin 7 of the Arduino.

14) Connect the Arduino to computer via USB cable.

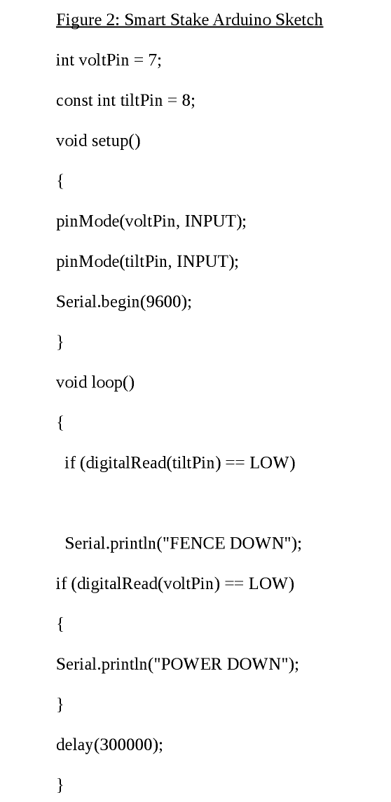

15) Compile sketch code (FIG. 2) in Arduino IDE and upload it to the Arduino.

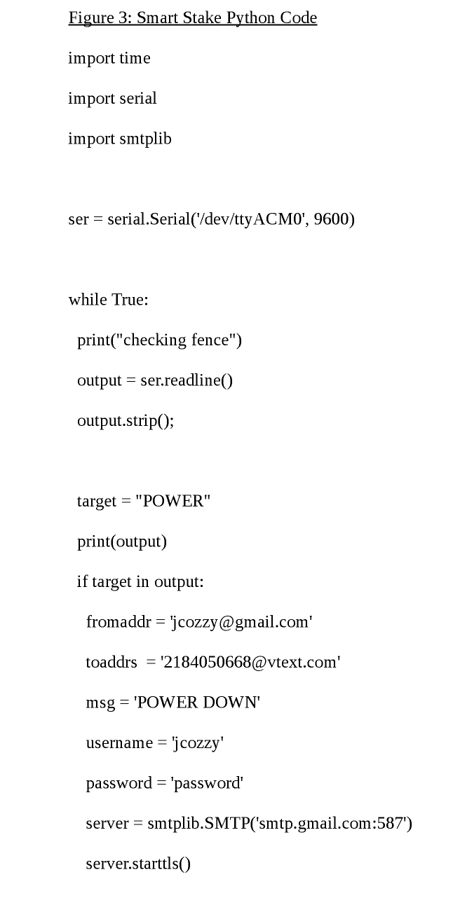

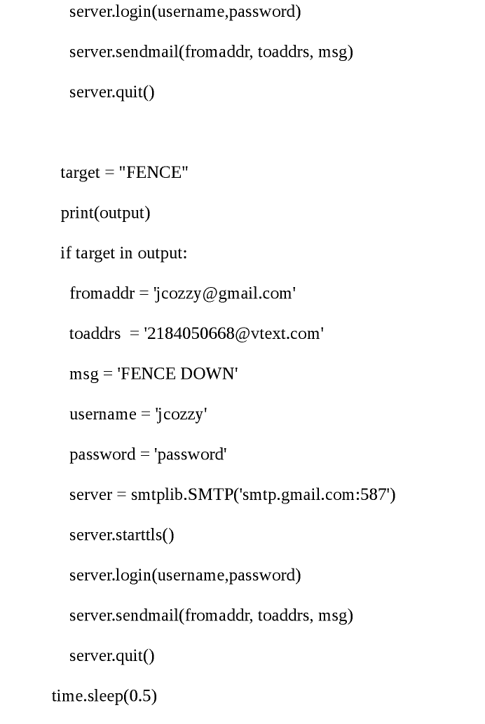

16) Compile Python code (FIG. 3) and run it for serial communication with the Arduino.

1. The immediate notification via Internet connection of the electrical fence power and/or structural conditions via the Smart Stake's hardware and program.
